(19) United States
(12) Patent Application Publication
(10) Pub. No.: US 2026/0184227 A1
(43) Pub. Date: Jul. 2, 2026

(54) EV CHARGE AND DISCHARGE SYSTEM

(71) Applicant: TMEIC Corporation, Tokyo (JP)

(72) Inventor: Xiangguo WANG, Chuo-ku, Tokyo (JP)

(73) Assignee: TMEIC Corporation, Tokyo (JP)

(21) Appl. No.: 19/130,124

(22) PCT Filed: Oct. 17, 2023
(86) PCT No.: PCT/JP2023/037588

§ 371 Date: May 15, 2025

(51) Int. Cl. B60L 53/67; B60L 53/62; B60L 53/63; B60L 55/00

(52) U.S. Cl. CPC B60L 53/67; B60L 53/62; B60L 53/63; B60L 55/00; B60L 2210/10; B60L 2210/30; B60L 2210/40; B60L 2240/80

(57) ABSTRACT

An EV charge and discharge system includes: a plurality of charge and discharge stations each configured to, when detachably connected with an EV, charge and discharge a power storage device mounted in the connected EV; a plurality of bidirectional converters provided so as to respectively correspond to the plurality of charge and discharge stations, and each configured to perform bidirectional power conversion in a direction of charging the power storage device of the EV connected with a corresponding charge and discharge station of the charge and discharge stations and in a direction of discharging the power storage device of the EV connected with the corresponding charge and discharge station; and a control device configured to control an operation of the plurality of bidirectional converters. The control device controls the bidirectional converters to allow each EV to attain a target charge ratio at an end of parking.

### TECHNICAL FIELD

Embodiments of the invention relate to an EV charge and discharge system.

### BACKGROUND ART

Power generating facilities using renewable energy are being introduced to realize carbon neutral. Meanwhile, power generating facilities using renewable energy have difficulty in attaining a stable amount of power generation, which is an issue. For example, in solar power generation, the amount of power generation changes in accordance with the time period, weather conditions, and so on.

Therefore, a proposal has been made to use a stationary storage battery, charge the storage battery when the amount of power generation is large, and discharge the storage battery when the amount of power generation is small, thereby achieving load leveling of power demand. Further, the use of a power storage device of an EV (electric vehicle) instead of a stationary storage battery has also been considered.

An EV charge and discharge system that is connected to a power generating facility using renewable energy and to a power system, that charges a power storage device of an EV based on power of at least one of the power generating facility and the power system, and that discharges the power stored in the power storage device of the EV toward the power system can charge the EV, achieve load leveling of power demand, and enable effective use of the power storage device of the EV.

For such an EV charge and discharge system, it is desirable to enable more effective use of the power storage device of the EV while further increasing the EV user's convenience.

### PRIOR ART DOCUMENTS

### Patent Literature

[Patent Literature 1] JP 2007-282383A
[Patent Literature 2] JP 2022-25664A
[Patent Literature 3] JP 2007-85689A

### SUMMARY OF INVENTION

### Problem to be Solved by the Invention

Embodiments of the invention provide an EV charge and discharge system enabling more effective use of a power storage device of an EV while further increasing the EV user's convenience.

### Means for Solving the Problem

According to an embodiment of the invention, there is provided an EV charge and discharge system connected to a power generating facility using renewable energy and to a power system, the EV charge and discharge system including: a plurality of charge and discharge stations each configured to, when detachably connected with an EV, charge and discharge a power storage device mounted in the connected EV; a plurality of bidirectional converters provided so as to respectively correspond to the plurality of charge and discharge stations, and each configured to perform bidirectional power conversion in a direction of charging the power storage device of the EV connected with a corresponding charge and discharge station of the charge and discharge stations and in a direction of discharging the power storage device of the EV connected with the corresponding charge and discharge station; and a control device configured to control an operation of the plurality of bidirectional converters, the plurality of bidirectional converters each being configured to in power conversion in the direction of charging, convert power supplied from at least one of the power generating facility and the power system into DC power corresponding to the EV, and supply the DC power after conversion to the corresponding charge and discharge station, and in power conversion in the direction of discharging, convert DC power supplied from the power storage device of the EV connected with the corresponding charge and discharge station into power for the power system, and supply the power after conversion toward the power system, the control device being configured to acquire information about a parking time of each EV of EVs connected with the plurality of charge and discharge stations and information about a target charge ratio at an end of parking of each EV of the EVs connected with the plurality of charge and discharge stations, and based on the acquired information about the parking time and the acquired information about the charge ratio, control the operation of the plurality of bidirectional converters in the direction of charging in a time period in which an amount of power generation of the power generating facility is large, and control the operation of the plurality of bidirectional converters in the direction of discharging in a time period in which the amount of power generation of the power generating facility is small, so as to allow each EV of the EVs respectively connected with the plurality of charge and discharge stations to attain the target charge ratio at the end of parking.

### Advantageous Effects of Invention

According to the embodiment of the invention, an EV charge and discharge system enabling more effective use of a power storage device of an EV while further increasing the EV user's convenience is provided.

### BRIEF DESCRIPTION OF DRAWINGS

FIG. 1 is a block diagram schematically illustrating an EV charge and discharge system according to an embodiment.

FIG. 2 is a block diagram schematically illustrating a modification of the EV charge and discharge system according to the embodiment.

### DESCRIPTION OF EMBODIMENTS

Hereinafter, embodiments will be described with reference to the drawings.

Note that the drawings are schematic or conceptual, and the relationship between the thickness and width of each portion, the proportions of sizes among portions, and so on are not necessarily the same as the actual values. Even the dimensions and proportion of the same portion may be illustrated differently depending on the drawing.

In the specification and drawings, components similar to those described in regard to a drawing thereinabove are marked with like reference numerals, and a detailed description is omitted as appropriate.

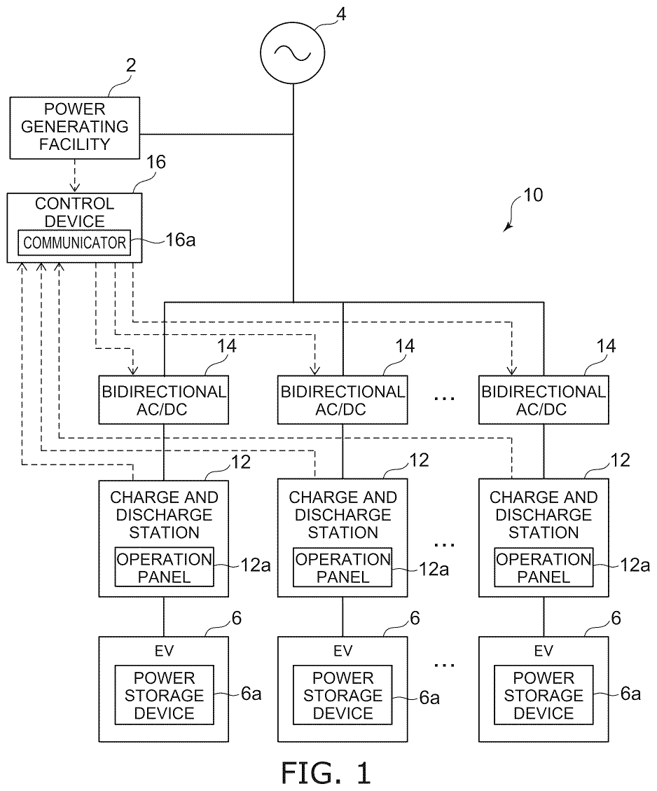

FIG. 1 is a block diagram schematically illustrating an EV charge and discharge system according to an embodiment.

As illustrated in FIG. 1, an EV charge and discharge system 10 includes a plurality of charge and discharge stations 12, a plurality of bidirectional AC/DC converters 14 (bidirectional converters), and a control device 16.

The EV charge and discharge system 10 is connected to a power generating facility 2 using renewable energy and to a power system 4. The EV charge and discharge system 10 is used together with the power generating facility 2 and the power system 4. The power system 4 is, for example, an AC power system. The power of the power system 4 is, for example, AC power. However, the power of the power system 4 is not limited to AC power and may be, for example, DC power.

The power generating facility 2 supplies generated power to the power system 4 and to the EV charge and discharge system 10. The power generating facility 2 is a grid-interconnected power generating facility. The power generating facility 2 is, for example, a solar power generating facility. The power generating facility 2 includes, for example, a solar panel and a power conversion device that converts DC power generated by the solar panel into AC power corresponding to the power system 4. However, the power generating facility 2 may be, for example, a wind power generating facility or a geothermal power generating facility. The power generating facility 2 may be any power generating facility that generates power using renewable energy and that can be interconnected with the power system 4.

The plurality of charge and discharge stations 12 are used for connection with an EV 6. The plurality of charge and discharge stations 12 are each a device that, when detachably connected with the EV 6, charges and discharges a power storage device 6a mounted in the connected EV 6. In other words, the plurality of charge and discharge stations 12 are each a charge and discharge plug detachably connected with a charge and discharge socket provided in the EV 6.

The EV charge and discharge system 10 is connected with the EV 6 via any of the plurality of charge and discharge stations 12. Accordingly, the EV charge and discharge system 10 can charge a number of EVs 6 corresponding to the number of charge and discharge stations 12.

Note that the EV 6 may be, for example, a BEV (Battery Electric Vehicle) that uses only a motor as a power source or a PHEV (Plug-in Hybrid Electric Vehicle) that uses a motor and an engine as power sources. The EV 6 may be any vehicle that includes the power storage device 6a, travels based on DC power stored in the power storage device 6a, and is capable of charging the power storage device 6a with external power supply. The power storage device 6a of the EV 6 is, for example, a storage battery or a capacitor. The power storage device 6a may be any device capable of storing DC power.

The EV charge and discharge system 10 charges the power storage devices 6a of the EVs 6 connected with the plurality of charge and discharge stations 12, based on power supplied from at least one of the power generating facility 2 and the power system 4. Further, the EV charge and discharge system 10 discharges the power stored in the power storage devices 6a of the EVs 6 connected with the plurality of charge and discharge stations 12 toward the power system 4. When the number of charge and discharge stations 12 (the number of EVs 6 that can be connected) is large and all power generated by the power generating facility 2 can be used for charging the EVs 6, the power generating facility 2 may be a self-consumption power generating facility.

The plurality of charge and discharge stations 12 have a function of communicating with the connected EV 6. The charge and discharge station 12 communicates with, for example, an ECU (Electronic Control Unit) of the EV 6. The charge and discharge station 12 communicates with the connected EV 6, thereby acquiring from the EV 6, information about the current charge ratio (State Of Charge: SOC) of the power storage device 6a. The information about the charge ratio of the power storage device 6a may be any information, such as information about the voltage value of the power storage device 6a, from which the charge and discharge station 12 can grasp the current charge ratio of the power storage device 6a. The information acquired from the EV 6 by the charge and discharge station 12 is not limited to the information about the charge ratio. The charge and discharge station 12 may further acquire from the EV 6, for example, information about an optimum current value (current instruction value) corresponding to the state of the power storage device 6a.

The plurality of bidirectional AC/DC converters 14 are provided so as to respectively correspond to the plurality of charge and discharge stations 12, and each perform bidirectional power conversion in a direction of charging the power storage device 6a of the EV 6 connected with the corresponding charge and discharge station 12 and in a direction of discharging the power storage device 6a of the EV 6 connected with the corresponding charge and discharge station 12.

The bidirectional AC/DC converter 14 converts AC power supplied from at least one of the power generating facility 2 and the power system 4 into DC power corresponding to the EV 6, and supplies the DC power after conversion to the corresponding charge and discharge station 12. The bidirectional AC/DC converter 14 converts DC power supplied from the power storage device 6a of the EV 6 connected with the corresponding charge and discharge station 12 into AC power corresponding to the power system 4, and supplies the AC power after conversion toward the power system 4.

As described above, in the power conversion in the direction of charging, the plurality of bidirectional AC/DC converters 14 each convert power supplied from at least one of the power generating facility 2 and the power system 4 into DC power corresponding to the EV 6, and supply the DC power after conversion to the corresponding charge and discharge station 12. In the power conversion in the direction of discharging, the plurality of bidirectional AC/DC converters 14 each convert DC power supplied from the power storage device 6a of the EV 6 connected with the corresponding charge and discharge station 12 into power for the power system 4, and supply the power after conversion toward the power system 4.

Accordingly, the plurality of bidirectional AC/DC converters 14 can each supply the AC power after conversion to the power system 4 and also to the AC side of another bidirectional AC/DC converter 14. In other words, the plurality of bidirectional AC/DC converters 14 enable the sale of power (reverse power flow) to the power system 4 based on the power stored in the power storage device 6a of an EV 6, and also enable charging of the power storage device 6a of another EV 6 based on the power stored in the power storage device 6a of the EV 6. The bidirectional AC/DC converter 14 is, for example, an AC/DC converter enabling bidirectional power conversion.

The rated voltages of the plurality of bidirectional AC/DC converters 14 on the DC side are, for example, higher than or equal to the total voltage of the power storage device 6a of the EV 6. The total voltage of the power storage device 6a of the EV 6 is, for example, about 400 V. In this case, the rated voltages of the plurality of bidirectional AC/DC converters 14 on the DC side are set to 400 V or higher. Note that the rated voltages of the plurality of bidirectional AC/DC converters 14 need not necessarily be the same.

The control device 16 controls the operation of the plurality of bidirectional AC/DC converters 14. The control device 16 acquires information about the parking time of each EV 6 of EVs 6 connected with the plurality of charge and discharge stations 12 and information about a target charge ratio at the end of parking of each EV 6 of the EVs 6 connected with the plurality of charge and discharge stations 12. More specifically, the information about the parking time is information indicating the time from the start of parking of the EV 6 to the scheduled end of parking. More specifically, the information about the charge ratio is information indicating a percentage of the SOC of the power storage device 6a desired to be attained at the scheduled end of parking of the EV 6.

The plurality of charge and discharge stations 12 each include an operation panel 12a for inputting parking time information and charge ratio information. When the user of the EV 6 connects the EV 6 with the charge and discharge station 12 to perform charging or discharging, the user inputs parking time information and charge ratio information via the operation panel 12a. The control device 16 communicates with the plurality of charge and discharge stations 12, thereby acquiring parking time information and charge ratio information from the plurality of charge and discharge stations 12.

The control device 16 includes a communicator 16a for communicating with an information terminal (not illustrated) via a network, such as the Internet. The information terminal is, for example, a smartphone or a personal computer owned by the user of the EV 6, or a dedicated terminal provided in a parking space where the plurality of charge and discharge stations 12 are placed. When the user of the EV 6 connects the EV 6 with the charge and discharge station 12 to perform charging or discharging, the user of the EV 6 may input parking time information and charge ratio information via the information terminal. The control device 16 may acquire parking time information and charge ratio information from the information terminal by communicating with the information terminal via the communicator 16a. Note that the communication between the communicator 16a and the information terminal may be wired communication or wireless communication.

As described above, for example, the control device 16 communicates with the plurality of charge and discharge stations 12 or the information terminal, thereby acquiring parking time information and charge ratio information. However, the method of acquiring parking time information and charge ratio information is not limited to the above, and may be any method allowing the control device 16 to appropriately acquire parking time information and charge ratio information.

Based on the acquired parking time information and charge ratio information, the control device 16 controls the operation of the plurality of bidirectional AC/DC converters 14 in the direction of charging in a time period in which the amount of power generation of the power generating facility 2 is large and controls the operation of the plurality of bidirectional AC/DC converters 14 in the direction of discharging in a time period in which the amount of power generation of the power generating facility 2 is small, so as to allow each EV of the EVs 6 respectively connected with the plurality of charge and discharge stations 12 to attain the target charge ratio at the end of parking.

For example, when the power generating facility 2 is a solar power generating facility, the amount of power generation of the power generating facility 2 tends to increase in a daytime period and decrease in a time period from evening to morning. Meanwhile, the spot market price in the wholesale electricity market tends to drop in a noon time period and rise in a time period from evening to night. The noon time period is, for example, a time period from 11:00 to 14:00. The time period from evening to night is, for example, a time period from 15:00 to 21:00.

Therefore, when the power generating facility 2 is a solar power generating facility, the control device 16 controls the operation of the plurality of bidirectional AC/DC converters 14 in the direction of charging in the daytime period in which the amount of power generation of the power generating facility 2 is large, and controls the operation of the plurality of bidirectional AC/DC converters 14 in the direction of discharging in the time period from evening to morning in which the amount of power generation of the power generating facility 2 is small. Accordingly, for example, revenues from the sale of power can be made higher than in a case of, for example, the sale of power in a time period in which the spot market price is low.

There may be a case where, for example, in a place of business, a plurality of EVs 6 owned by employees and used for commuting are just parked in a parking area in the place of business during daytime business hours. In such a case, the EV charge and discharge system 10 according to the embodiment is applied, the plurality of EVs 6 are charged during daytime business hours (for example, 11:00 to 14:00), and the plurality of EVs 6 are discharged in an evening time period immediately before the employees return home (for example, 15:00 to 17:00).

Accordingly, for example, the business operators that operate the power generating facility 2 and the EV charge and discharge system 10 can increase revenues from the sale of power by charging in a time period in which the spot market price is low and discharging in a time period in which the spot market price is high. An employee (user) who owns the EV 6 can charge the power storage device 6a of the EV 6 up to a desired charge ratio by the time to return home. For example, an employee can charge their EV 6 for free in return for allowing the employee's EV 6 to be used instead of a stationary storage battery. This can bring benefits to both the business operators and the employees (users), and enables more effective use of the plurality of EVs 6 than in a case where the plurality of EVs 6 are just parked. Since the power storage device 6a of the EV 6 is charged and discharged so as to attain the target charge ratio at the end of parking (for example, at the time to return home), the convenience of the user of the EV 6 can be further increased.

Therefore, the EV charge and discharge system 10 according to the embodiment can enable more effective use of the power storage device 6a of the EV 6 while further increasing the convenience of the user of the EV 6.

For example, when the parking time of the EV 6 overlaps each of the time period in which the amount of power generation of the power generating facility 2 is large and the time period in which the amount of power generation of the power generating facility 2 is small and when information about the charge ratio is set to less than 100%, the control device 16 charges the power storage device 6a of the EV 6 to a charge ratio higher than the target charge ratio in the time period in which the amount of power generation of the power generating facility 2 is large, and thereafter, discharges the power storage device 6a of the EV 6 in the time period in which the amount of power generation of the power generating facility 2 is small, so as to attain the target charge ratio at the end of parking.

For example, the control device 16 assumes that the parking time of an EV 6 is from 9:00 to 18:00 and that the target charge ratio is set to 25%. In this case, for example, the control device 16 charges the power storage device 6a of the EV 6 in a time period from 9:00 to 15:00 to charge the power storage device 6a of the EV 6 to a charge ratio higher than 25%, and thereafter, discharges the power storage device 6a of the EV 6 in a time period from 15:00 to 18:00 to change the charge ratio of the power storage device 6a of the EV 6 to 25%. This can, for example, further increase revenues from the sale of the power, and enable more effective use of the power storage device 6a of the EV 6.

Note that the charge ratio need not necessarily be set to less than 100%. For example, before a holiday or the like, the charge ratio can be set to 100% to return home. As described above, when the target charge ratio at the end of parking can be set as desired, the convenience of the user of the EV 6 can be further increased.

Further, the control device 16 acquires, for example, information about the dischargeable amount of the power storage device 6a that is allowable during the parking time. For example, similarly to parking time information and charge ratio information, the control device 16 acquires information about the dischargeable amount by communicating with the plurality of charge and discharge stations 12 or the information terminal. However, the method of acquiring information about the dischargeable amount is not limited to the above, and may be any method.

The control device 16 determines the charge amount of the power storage device 6a and the discharge amount of the power storage device 6a, based on the acquired information about the dischargeable amount.

Further, the control device 16 acquires, for example, information about the chargeable amount of the power storage device 6a that is allowable during the parking time. For example, similarly to parking time information and charge ratio information, the control device 16 acquires information about the chargeable amount by communicating with the plurality of charge and discharge stations 12 or the information terminal. However, the method of acquiring information about the chargeable amount is not limited to the above, and may be any method.

The control device 16 determines the charge amount of the power storage device 6a and the discharge amount of the power storage device 6a, based on the acquired information about the chargeable amount. That is, the control device 16 determines the charge amount of the power storage device 6a and the discharge amount of the power storage device 6a, based on the information about the dischargeable amount and the information about the chargeable amount. Note that the control device 16 need not necessarily acquire both the dischargeable amount information and the chargeable amount information. The control device 16 may acquire only one of the dischargeable amount information and the chargeable amount information, and determine the charge amount of the power storage device 6a and the discharge amount of the power storage device 6a based on the acquired one of the pieces of information.

For example, it is assumed that the parking time of an EV 6 is set to a time from 9:00 to 18:00, the target charge ratio is set to 25%, the allowable chargeable amount is set to an amount equivalent to 75% SOC, and the allowable dischargeable amount is set to an amount equivalent to 60% SOC. It is further assumed that the charge ratio of the power storage device 6a at the start of charging is 10% SOC. In this case, for example, the control device 16 charges the power storage device 6a of the EV 6 in a time period from 9:00 to 15:00 to charge the power storage device 6a of the EV 6 to 85% SOC, and thereafter, discharges the power storage device 6a of the EV 6 in a time period from 15:00 to 18:00 to change the charge ratio of the power storage device 6a of the EV 6 to 25%.

As described above, the allowable chargeable amount and dischargeable amount are allowed to be set as desired. Accordingly, for example, a user who wants to set the charge amount at the time to return home to a high charge amount can increase the allowable chargeable amount. For example, a user who is concerned about deterioration of the power storage device 6a due to charging and discharging can decrease the allowable dischargeable amount. As described above, since the chargeable amount and the dischargeable amount are allowed to be set as desired in accordance with, for example, the user's preference, the convenience of the user of the EV 6 can be further increased.

Further, the control device 16 can acquire information about a change in the parking time of the EV 6. For example, similarly to parking time information and charge ratio information, the control device 16 acquires information about a change in the parking time of the EV 6 by communicating with the plurality of charge and discharge stations 12 or the information terminal. For example, when the user of the EV 6 wants to change the parking time because of, for example, unexpected going out, the user operates an information terminal, such as a smartphone, owned by the user to transmit to the control device 16, information about the change in the parking time of the EV 6. However, the method of acquiring information about the change in the parking time of the EV 6 is not limited to the above, and may be any method.

In response to acquiring the information about the change in the parking time of the EV 6, the control device 16 performs a process of changing the parking time. For example, when the current charge ratio of the EV 6 concerned is different from the target charge ratio at the end of parking, the control device 16 performs a process of charging or discharging the power storage device 6a of the EV 6 concerned so as to attain the target charge ratio at the end of the changed parking time. As described above, since the parking time of the EV 6 is allowed to be changed, the charge ratio of the EV 6 can be prevented from becoming different from a desired charge ratio even upon, for example, unexpected going out. Accordingly, for example, the convenience of the user of the EV 6 can be further increased.

When the charge ratio of the EV 6 is lower than the target charge ratio at the time when the control device 16 acquires information about a change in the parking time of the EV 6, the control device 16 performs any of charging of the power storage device 6a based on surplus power of the power generating facility 2, charging of the power storage device 6a based on the power stored in the power storage device 6a of another dischargeable EV 6 among the EVs 6 connected with the plurality of charge and discharge stations 12, stopping of charging of another EV 6 among the EVs 6 connected with the plurality of charge and discharge stations 12, and charging of the power storage device 6a based on the power of the power system 4, in descending order of priority as necessary, so as to attain the target charge ratio at the end of the changed parking.

For example, when the time until the end of the changed parking is short, the control device 16 rapidly charges the power storage device 6a of the EV 6 for which the parking time has been changed, based on surplus power of the power generating facility 2, the power stored in the power storage device 6a of another EV 6, and the power of the power system 4. Accordingly, the charge ratio of the EV 6 can be further prevented from becoming different from the desired charge ratio.

At this time, the control device 16 charges the power storage device 6a of the EV 6 for which the parking time has been changed, based on surplus power of the power generating facility 2, which is given the highest priority. When the surplus power of the power generating facility 2 alone is not sufficient, the control device 16 charges the power storage device 6a of the EV 6 for which the parking time has been changed, by also using the power stored in the power storage devices 6a of another EV 6. When the surplus power of the power generating facility 2 and the power stored in the power storage devices 6a of another EV 6 are not sufficient, the control device 16 stops charging of another EV 6 that can be stopped, thereby increasing power that can be used to charge the power storage device 6a of the EV 6 for which the parking time has been changed. When the surplus power of the power generating facility 2 and the power stored in the power storage devices 6a of another EV 6 are not sufficient and another EV 6 for which charging can be stopped is not present, the control device 16 charges the power storage device 6a of the EV 6 for which the parking time has been changed, by also using the power of the power system 4.

As described above, any of charging of the power storage device 6a based on surplus power of the power generating facility 2, charging of the power storage device 6a based on the power stored in the power storage device 6a of another dischargeable EV 6 among the EVs 6 connected with the plurality of charge and discharge stations 12, stopping of charging of another EV 6 among the EVs 6 connected with the plurality of charge and discharge stations 12, and charging of the power storage device 6a based on the power of the power system 4 is performed, in descending order of priority as necessary. When the surplus power of the power generating facility 2 and the power stored in the power storage device 6a of another EV 6, which are given priority, are thus used, the use amount of power from the power system 4 can be reduced even when the power storage device 6a of the EV 6 for which the parking time has been changed is charged. For example, the contract demand fee associated with the use of the power of the power system 4 can be reduced.

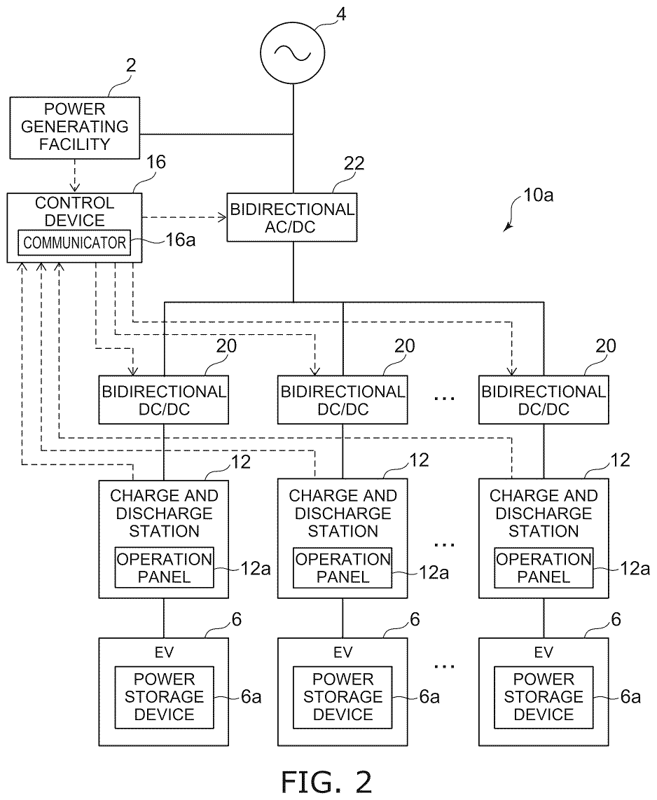

FIG. 2 is a block diagram schematically illustrating a modification of the EV charge and discharge system according to the embodiment.

As illustrated in FIG. 2, in an EV charge and discharge system 10a, the plurality of bidirectional AC/DC converters 14 are replaced with a plurality of bidirectional DC/DC converters 20 (bidirectional converters). The EV charge and discharge system 10a further includes a bidirectional AC/DC converter 22.

The bidirectional AC/DC converter 22 converts AC power supplied from the power system 4 into DC power, and also converts DC power into AC power corresponding to the power system 4 and supplies the AC power after conversion to the power system 4.

The plurality of bidirectional DC/DC converters 20 are provided so as to respectively correspond to the plurality of charge and discharge stations 12, and each perform bidirectional power conversion in a direction of charging the power storage device 6a of the EV 6 connected with the corresponding charge and discharge station 12 and in a direction of discharging the power storage device 6a of the EV 6 connected with the corresponding charge and discharge station 12.

The bidirectional DC/DC converter 20 converts DC power obtained by conversion, by the bidirectional AC/DC converter 22, of power supplied from at least one of the power generating facility 2 and the power system 4 into other DC power corresponding to the EV 6, and supplies the DC power after conversion to the corresponding charge and discharge station 12. The bidirectional DC/DC converter 20 converts DC power supplied from the power storage device 6a of the EV 6 connected with the corresponding charge and discharge station 12 into DC power corresponding to the bidirectional AC/DC converter 22, and supplies the DC power after conversion to the bidirectional AC/DC converter 22. The bidirectional AC/DC converter 22 converts the DC power supplied from the plurality of bidirectional DC/DC converters 20 into AC power corresponding to the power system 4.

As described above, in the power conversion in the direction of charging, the plurality of bidirectional DC/DC converters 20 each convert power supplied from at least one of the power generating facility 2 and the power system 4 into DC power corresponding to the EV 6, and supply the DC power after conversion to the corresponding charge and discharge station 12. In the power conversion in the direction of discharging, the plurality of bidirectional DC/DC converters 20 each convert DC power supplied from the power storage device 6a of the EV 6 connected with the corresponding charge and discharge station 12 into DC power for the bidirectional AC/DC converter 22 (power system 4), and supply the power after conversion toward the bidirectional AC/DC converter 22.

Accordingly, the plurality of bidirectional DC/DC converters 20 can each supply the DC power after conversion to the bidirectional AC/DC converter 22 and also to another bidirectional DC/DC converter 20. In other words, the plurality of bidirectional DC/DC converters 20 enable the sale of power (reverse power flow) to the power system 4 based on the power stored in the power storage device 6a of an EV 6, and also enable charging of the power storage device 6a of another EV 6 based on the power stored in the power storage device 6a of the EV 6. The bidirectional DC/DC converter 20 is, for example, a DC/DC converter enabling bidirectional power conversion.

The control device 16 controls the operation of the plurality of bidirectional DC/DC converters 20 and also controls the operation of the bidirectional AC/DC converter 22. The control device 16 controls the direction of power conversion by the bidirectional AC/DC converter 22 and the magnitude of power to be converted, in accordance with the total power of the plurality of bidirectional DC/DC converters 20 in the direction of charging and the total power thereof in the direction of discharging. Accordingly, the operation of the bidirectional AC/DC converter 22 allows power supplied from at least one of the power generating facility 2 and the power system 4 to be supplied to the plurality of bidirectional DC/DC converters 20, and also enables the sale of power (reverse power flow) to the power system 4 based on the power stored in the power storage devices 6a of the EVs 6.

As described above, the plurality of bidirectional converters may be the bidirectional AC/DC converters 14 or the bidirectional DC/DC converters 20. Supply of power from a bidirectional converter to another bidirectional converter (supply of power from an EV 6 to another EV 6) may be performed with AC power or DC power. The configuration of the plurality of bidirectional converters is not limited to the above and may be any configuration in which the plurality of bidirectional converters are provided so as to respectively correspond to the plurality of charge and discharge stations 12 and can each perform bidirectional power conversion in a direction of charging the power storage device 6a of the EV 6 connected with the corresponding charge and discharge station 12 and in a direction of discharging the power storage device 6a of the EV 6 connected with the corresponding charge and discharge station 12.

The embodiment includes the following forms.

### Appendix 1

An EV charge and discharge system connected to a power generating facility using renewable energy and to a power system, the EV charge and discharge system including:
a plurality of charge and discharge stations each configured to, when detachably connected with an EV, charge and discharge a power storage device mounted in the connected EV;
a plurality of bidirectional converters provided so as to respectively correspond to the plurality of charge and discharge stations, and each configured to perform bidirectional power conversion in a direction of charging the power storage device of the EV connected with a corresponding charge and discharge station of the charge and discharge stations and in a direction of discharging the power storage device of the EV connected with the corresponding charge and discharge station; and
a control device configured to control an operation of the plurality of bidirectional converters,
the plurality of bidirectional converters each being configured to in power conversion in the direction of charging, convert power supplied from at least one of the power generating facility and the power system into DC power corresponding to the EV, and supply the DC power after conversion to the corresponding charge and discharge station, and in power conversion in the direction of discharging, convert DC power supplied from the power storage device of the EV connected with the corresponding charge and discharge station into power for the power system, and supply the power after conversion toward the power system,
the control device being configured to acquire information about a parking time of each EV of EVs connected with the plurality of charge and discharge stations and information about a target charge ratio at an end of parking of each EV of the EVs connected with the plurality of charge and discharge stations, and based on the acquired information about the parking time and the acquired information about the charge ratio, control the operation of the plurality of bidirectional converters in the direction of charging in a time period in which an amount of power generation of the power generating facility is large, and control the operation of the plurality of bidirectional converters in the direction of discharging in a time period in which the amount of power generation of the power generating facility is small, so as to allow each EV of the EVs respectively connected with the plurality of charge and discharge stations to attain the target charge ratio at the end of parking.

### Appendix 2

The EV charge and discharge system according to appendix 1, in which the control device is configured to, when the parking time of the EV overlaps each of the time period in which the amount of power generation of the power generating facility is large and the time period in which the amount of power generation of the power generating facility is small and when the information about the charge ratio is set to less than 100%, charge the power storage device of the EV to a charge ratio higher than the target charge ratio in the time period in which the amount of power generation of the power generating facility is large, and thereafter, discharge the power storage device of the EV in the time period in which the amount of power generation of the power generating facility is small so as to attain the target charge ratio at the end of parking.

### Appendix 3

The EV charge and discharge system according to appendix 2, in which the control device is configured to acquire information about a dischargeable amount of the power storage device, the dischargeable amount being allowable during the parking time, and determine a charge amount of the power storage device and a discharge amount of the power storage device, based on the acquired information about the dischargeable amount.

### Appendix 4

The EV charge and discharge system according to appendix 2 or 3, in which the control device is configured to acquire information about a chargeable amount of the power storage device, the chargeable amount being allowable during the parking time, and determine a charge amount of the power storage device and a discharge amount of the power storage device, based on the acquired information about the chargeable amount.

### Appendix 5

The EV charge and discharge system according to any one of appendixes 1 to 4, in which the control device is capable of acquiring information about a change in the parking time of the EV, and is configured to, in response to acquiring the information about the change in the parking time of the EV, perform a process of changing the parking time.

### Appendix 6

The EV charge and discharge system according to appendix 5, in which the control device is configured to, when a charge ratio of the EV is lower than the target charge ratio at a time when the control device acquires the information about the change in the parking time of the EV, perform any of charging of the power storage device based on surplus power of the power generating facility, charging of the power storage device based on power stored in the power storage device of an other dischargeable EV among the EVs connected with the plurality of charge and discharge stations, stopping of charging of an other EV among the EVs connected with the plurality of charge and discharge stations, and charging of the power storage device based on power of the power system, in descending order of priority as necessary, so as to attain the target charge ratio at an end of parking after the change.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

### REFERENCE NUMERAL LIST

2 power generating facility
4 power system
6 EV (electric vehicle)
6a power storage device
10, 10a EV charge and discharge system
12 charge and discharge station
14 bidirectional AC/DC converter
16 control device
20 bidirectional DC/DC converter
22 bidirectional AC/DC converter

1. An EV charge and discharge system connected to a power generating facility using renewable energy and to a power system, the EV charge and discharge system comprising:
a plurality of charge and discharge stations each configured to, when detachably connected with an EV, charge and discharge a power storage device mounted in the connected EV;
a plurality of bidirectional converters provided so as to respectively correspond to the plurality of charge and discharge stations, and each configured to perform bidirectional power conversion in a direction of charging the power storage device of the EV connected with a corresponding charge and discharge station of the charge and discharge stations and in a direction of discharging the power storage device of the EV connected with the corresponding charge and discharge station; and
a control device configured to control an operation of the plurality of bidirectional converters,
the plurality of bidirectional converters each being configured to in power conversion in the direction of charging, convert power supplied from at least one of the power generating facility and the power system into DC power corresponding to the EV, and supply the DC power after conversion to the corresponding charge and discharge station, and in power conversion in the direction of discharging, convert DC power supplied from the power storage device of the EV connected with the corresponding charge and discharge station into power for the power system, and supply the power after conversion toward the power system,
the control device being configured to acquire information about a parking time of each EV of EVs connected with the plurality of charge and discharge stations and information about a target charge ratio at an end of parking of each EV of the EVs connected with the plurality of charge and discharge stations, and based on the acquired information about the parking time and the acquired information about the charge ratio, control the operation of the plurality of bidirectional converters in the direction of charging in a time period in which an amount of power generation of the power generating facility is large, and control the operation of the plurality of bidirectional converters in the direction of discharging in a time period in which the amount of power generation of the power generating facility is small, so as to allow each EV of the EVs respectively connected with the plurality of charge and discharge stations to attain the target charge ratio at the end of parking.

2. The EV charge and discharge system according to claim 1, wherein the control device is configured to, when the parking time of the EV overlaps each of the time period in which the amount of power generation of the power generating facility is large and the time period in which the amount of power generation of the power generating facility is small and when the information about the charge ratio is set to less than 100%, charge the power storage device of the EV to a charge ratio higher than the target charge ratio in the time period in which the amount of power generation of the power generating facility is large, and thereafter, discharge the power storage device of the EV in the time period in which the amount of power generation of the power generating facility is small so as to attain the target charge ratio at the end of parking.

3. The EV charge and discharge system according to claim 2, wherein the control device is configured to acquire information about a dischargeable amount of the power storage device, the dischargeable amount being allowable during the parking time, and determine a charge amount of the power storage device and a discharge amount of the power storage device, based on the acquired information about the dischargeable amount.

4. The EV charge and discharge system according to claim 2, wherein the control device is configured to acquire information about a chargeable amount of the power storage device, the chargeable amount being allowable during the parking time, and determine a charge amount of the power storage device and a discharge amount of the power storage device, based on the acquired information about the chargeable amount.

5. The EV charge and discharge system according to claim 1, wherein the control device is capable of acquiring information about a change in the parking time of the EV, and is configured to, in response to acquiring the information about the change in the parking time of the EV, perform a process of changing the parking time.

6. The EV charge and discharge system according to claim 5, wherein the control device is configured to, when a charge ratio of the EV is lower than the target charge ratio at a time when the control device acquires the information about the change in the parking time of the EV, perform any of charging of the power storage device based on surplus power of the power generating facility, charging of the power storage device based on power stored in the power storage device of an other dischargeable EV among the EVs connected with the plurality of charge and discharge stations, stopping of charging of an other EV among the EVs connected with the plurality of charge and discharge stations, and charging of the power storage device based on power of the power system, in descending order of priority as necessary, so as to attain the target charge ratio at an end of parking after the change.
